(19) United States
(12) Patent Application Publication
(10) Pub. No.: US 2021/0037030 A1
(43) Pub. Date: Feb. 4, 2021

(54) ANOMALY DETECTION BASED ON DATA RECORDS

(71) Applicant: International Business Machines Corporation, Armonk, NY (US)

(72) Inventors: Nicholas Marion, Poughkeepsie, NY (US); Steven LaFalce, Salt Point, NY (US); Neil Shah, Wappingers Falls, NY (US); Anthony Thomas Sofia, Hopewell-Junction, NY (US)

(21) Appl. No.: 16/524,433

(22) Filed: Jul. 29, 2019

(51) Int. Cl. H04L 29/06; G06F 16/245; G06F 9/54

(52) U.S. Cl. CPC H04L 63/1425; H04L 63/1416; G06F 9/54; G06F 16/245

(57) ABSTRACT

An example computer-implemented method includes receiving, by a processing device, the data records. The data records can be of a plurality of data record types. The method further includes analyzing, by the processing device, the data records by comparing the data records of different record types. The method further includes identifying, by the processing device and based at least in part on the analysis, a unit of work that is flooding the data records as the anomaly.

### BACKGROUND

The present invention generally relates to anomaly detection within a processing system, and more specifically, to anomaly detection based on data records.

A mainframe processing system can record activities for units of work that occur on the system. Units of work can represent, but are not limited to, a time sharing option (TSO) session, an advanced program-to-program communication/multiple virtual storage (APPC/MVS) transaction, a z/OS UNIX system services (OMVS) forked or spawned address space, a started task or batch jobs, etc. Such activities can include storage read/write activities, memory usage, network activity, software usage, errors, processing resource usage, and the like. These activities can be recorded as data records. An example of such data records include system management facilities (SMF) records, which provide a standardized method of storing records of activities to a file or data set. SMF records can be quite extensive and numerous.

### SUMMARY

Embodiments of the present invention are directed to a computer-implemented method for anomaly detection based on data records. A non-limiting example of the computer-implemented method includes receiving, by a processing device, the data records. The data records can be of a plurality of data record types. The method further includes analyzing, by the processing device, the data records by comparing the data records of different record types. The method further includes identifying, by the processing device and based at least in part on the analysis, a unit of work that is flooding the data records as the anomaly.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a table of a summary activity report for system management facilities records according to one or more embodiments described herein;

FIG. 2 depicts tables of two system management facilities record count metrics according to one or more embodiments described herein; and

FIG. 3 depicts tables of two system management facilities records generated by unit of work according to one or more embodiments described herein;

FIG. 4 depicts a block diagram of a processing system for anomaly detection based on system management facilities records according to one or more embodiments described herein;

FIG. 5 depicts a flow diagram of a method for anomaly detection based on data records according to one or more embodiments described herein;

FIG. 6 depicts a cloud computing environment according to one or more embodiments described herein;

FIG. 7 depicts abstraction model layers according to one or more embodiments described herein; and

FIG. 8 depicts a block diagram of a processing system for implementing the presently described techniques according to one or more embodiments described herein.

The diagrams depicted herein are illustrative. There can be many variations to the diagrams or the operations described therein without departing from the scope of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Techniques for anomaly detection based on system management facilities (SMF) records are provided by one or more embodiments of the present invention. SMF records provide information about what activities have occurred in a processing system, such as a mainframe processing system. Consequently, the information (i.e., data) contained within the SMF records can be useful to perform anomaly detection. Some examples of these anomalies can include but are not limited to, the following: a unit of work that flooded a system with SMF records, a sudden spike in central processing unit (CPU) usage, and a malicious user attempting to access unauthorized data.

Anomalies can be detected by analyzing certain fields or features in SMF records. Each SMF record type has a different layout, and mappings between SMF records of different SMF record types are known. However, due to the volume of SMF records and variation in SMF record types, traditional approaches to identifying an anomaly among a collection of SMF records are time-consuming, manual, and require expert knowledge of SMF record types. For example, SMF records can number in the millions for a twenty-four hour period of time; therefore, it is not feasible for an individual to analyze these records. Moreover, the time that manual analysis would take could cause additional problems. For example, if it takes days to analyze the SMF records, and the anomaly is due to a security issue or malicious attack, the delay of the manual analysis can result in a delay between the initial issue and the identification (and eventual remediation/mitigation) of that issue.

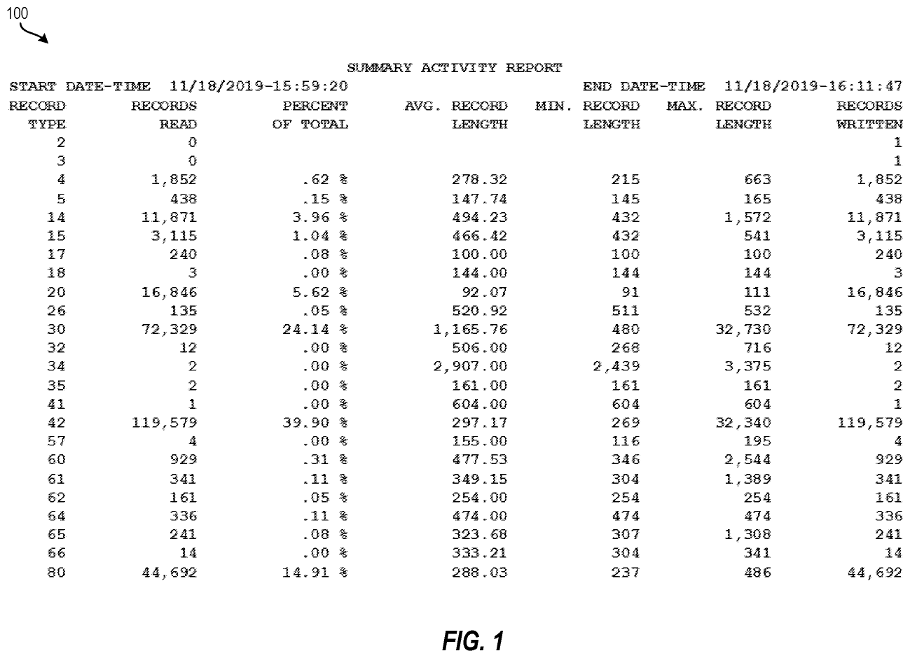

An example of a manual analysis approach to analyzing SMF records to identify a unit of work that flooded the processing system is as follows. First, a user runs a batch job that executes a dump program, which unloads SMF raw data and generates a summary of the SMF records (also referred to as a summary activity report). The summary includes the SMF record types and their respective counts, as well as other information in examples. As one example, FIG. 1 depicts a table 100 of a summary activity report for system management facilities records. Next, the user analyzes the summary of the SMF records to determine the SMF record type that has the highest count. Finally, using the data gathered in the analysis, the user analyzes all the SMF records in that SMF record type and identifies a specific SMF record with the highest count and extracts the relevant fields (such as user ID, jobname, etc.). The user aggregates the results to identify the user ID or jobname with the highest count (i.e., the unit of work that is flooding the SMF records).

One existing tool for analyzing SMF records identifies the SMF record type with the highest count and the unit of work that had the highest count within that record type. However, this approach fails to consider several important aspects.

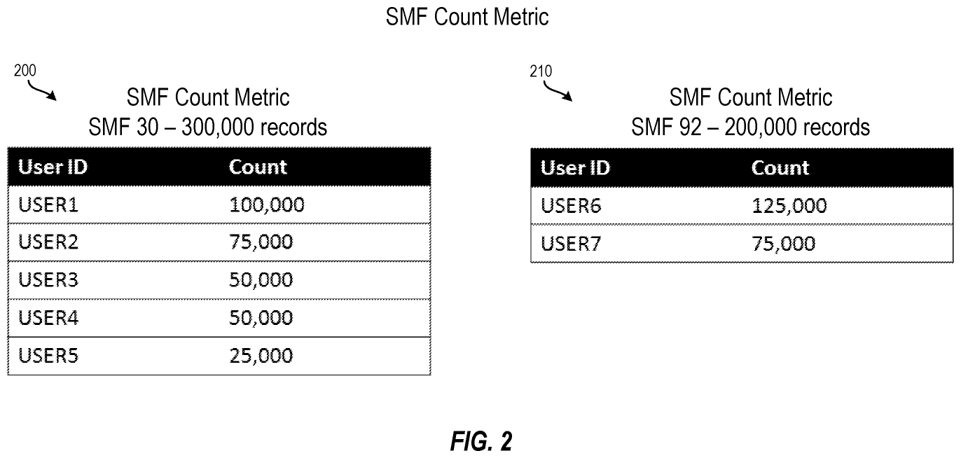

First, this approach fails to consider the SMF record count metric. Such an example is depicted in FIG. 2, which depicts tables 200, 210 of two SMF record count metrics for different SMF record types according to one or more embodiments described herein. The table 200, for SMF record type 30, contains user IDs and their associated record count (e.g., USER1 with an associated record count of 100,000; USER2 with an associated record count of 75,000; etc.). A total of 300,000 records of SMF record type 30 are shown. The table 210, for SMF record type 92, contains user IDs and their associated record count (e.g., USER6 with an associated record count of 125,000 and USER7 with an associated record count of 75,000). A total of 200,000 records are shown. In this example, the SMF record type with the highest count and corresponding user ID or jobname does not always indicate which unit of work caused the problem. In this example, the SMF record type 30 (table 200) is flagged as the flood because it has 300,000 records vs. 200,000 records for the SMF record type 92 (table 210). However, this approach fails to consider that a unit of work could cause a flood of a different record type that is not the top occurring record type. For instance, in the example of FIG. 2, USER6 actually caused a flood (125,000 records) of a different record type (the SMF record type 92) that is not the top occurring record type (the SMF record type 30 is the top occurring record type). This is not reflected by merely designating the highest record count among SMF record types.

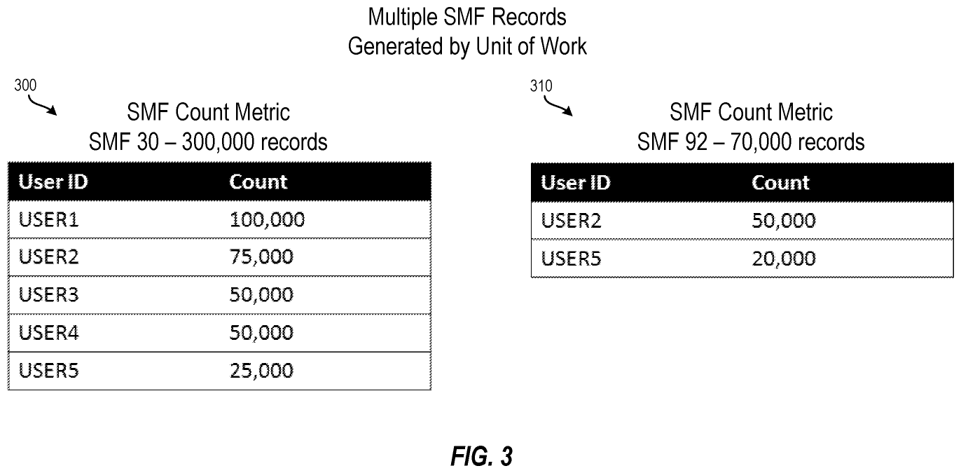

Second, this approach fails to consider multiple SMF records generated by a unit of work. Such an example is depicted in FIG. 3, which depicts tables 300, 310 of two system management facilities records generated by a unit of work according to one or more embodiments described herein. The table 300, for SMF record type 30, contains user IDs and their associated record count (e.g., USER1 with an associated record count of 100,000; USER2 with an associated record count of 75,000; etc.). A total of 300,000 records of SMF record type 30 are shown. The table 310, for SMF record type 92, contains user IDs and their associated record count (e.g., USER2 with an associated record count of 50,000 and USERS with an associated record count of 20,000). A total of 70,000 records are shown. In this example, units of work can cause several SMF record types to be generated. Not taking these into account can cause an incorrect unit of work to be implicated. For instance, in this example, USER2 is responsible for 125,000 records (75,000 from SMF record type 30 (table 300) and 50,000 from SMF record type 92 (table 310)), which exceeds the total for any other user.

The present techniques provide technical solutions to these technical problems by considering SMF records of various types and formats. Turning now to an overview of the aspects of the invention, one or more embodiments of the invention address the above-described shortcomings of the prior art by collecting identification features (e.g., user ID, jobname, etc.) for multiple SMF record types, sorting their occurrences (regardless of which SMF record type had the highest occurrence), and identifying a single unit of work as being a cause of an anomaly. Further, the SMF records created by that unit of work are combined/aggregated, regardless of the SMF record type, and the unit of work with the most occurrences within the SMF records (across the different SMF record types) is identified as the anomaly. A unit of work can be any activity or action that generates a data record, such as an SMF record.

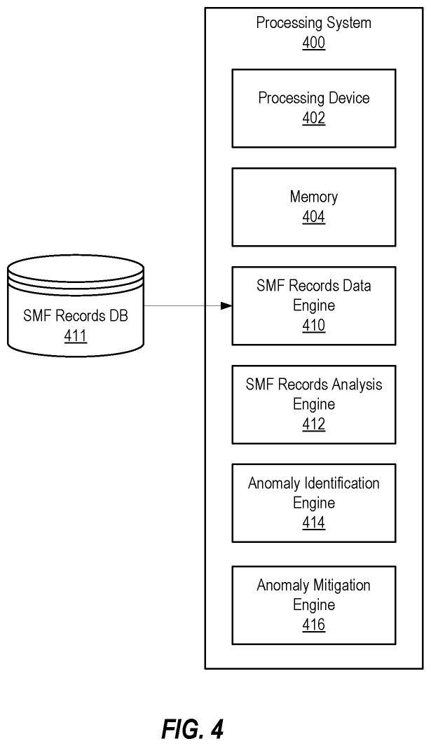

Turning now to a more detailed description of aspects of the present invention, FIG. 4 depicts a block diagram of a processing system 400 for anomaly detection based on system management facilities records according to one or more embodiments described herein. The processing system 400 includes a processing device 402 (e.g., one or more processors or other suitable devices for processing data), a memory 404, an SMF records data engine 410, an SMF records analysis engine 412, an anomaly identification engine 414, and an anomaly mitigation engine 416.

The various components, modules, engines, etc. described regarding FIG. 4 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming The programming can be processor executable instructions stored on a tangible memory, and the hardware can include the processing device 402 for executing those instructions. Thus a system memory (e.g., memory 404) can store program instructions that when executed by the processing device 402 implement the engines described herein. Other engines can also be utilized to include other features and functionality described in other examples herein.

According to an example, the functionality of the SMF records data engine 410, the SMF records analysis engine 412, and/or the anomaly identification engine 414 can be implemented as an application programming interface (API). In such an example, a user can “call” the API from a computing device (not shown) associated with the user, which can differ from the processing system 400. This enables the user to analyze SMF records and identify anomalies on data that may not reside on the user's own computing device. An example API invocation call is as follows: Return_SMF_Anomaly=Find_SMF_Anomaly(SMF_data). Using an API provides the advantage of shielding complexities of the SMF record layout from the user.

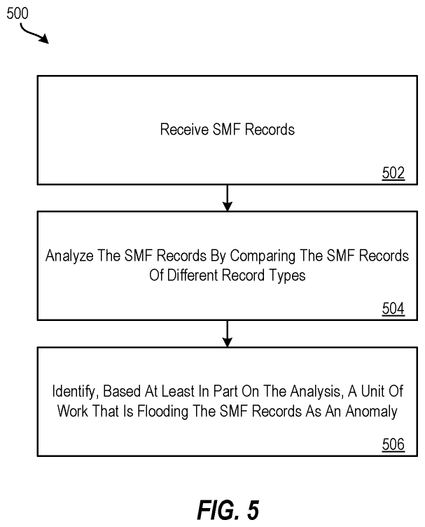

The features and functionality of the engines of the processing system 400 of FIG. 4 are now described with reference to FIG. 5, which depicts a flow diagram of a method 500 for anomaly detection based on data records according to embodiments of the present invention. Although the data records can be any suitable type of record, FIG. 5 is described with reference to the data records being system management facilities (SMF) records.

At block 502, the SMF records data engine 410 receives SMF records, such as from an SMF records database 411. The SMF records database 411 can be any suitable data storage repository (or repositories) for storing data, such as SMF records. The SMF records database 411 can also store a summary activity report for SMF records, such as shown in the table 100 of FIG. 1. In examples, identification features (e.g., user ID, jobname, etc.) are collected for multiple SMF record types and stored in the SMF records database 411. The identification features identify a source, such as a job or a user, that caused the SMF records with which they are associated to be created.

At block 504, the SMF records analysis engine 412 analyses the SMF records by comparing the SMF records of different record types. The SMF records analysis engine 412 can sort the occurrences of the identification features, such as in descending order of a number of the occurrences (e.g., a higher number first in the order). The sort occurs regardless of which SMF record type had the highest occurrence (i.e., highest count).

At block 506, the anomaly identification engine 414 identifies, based at least in part on the analysis, a unit of work that is flooding the SMF records as the anomaly. To do this, the anomaly identification engine 414 combines or aggregates the SMF records created by each unit of work, regardless of record type, from the SMF records analysis engine 412. The anomaly identification engine 414 identifies the unit of work as flooding the SMF records as being the unit of work with the most occurrences (i.e., highest count), regardless of record type.

According to one or more embodiments described herein, the present techniques can also detect anomalies that are not flood-related. For example, the anomaly identification engine 414 identifies an anomaly by identifying features of interest across multiple SMF record types and determining a highest occurring feature of interest as being the anomaly. Features of interest represent features of SMF records that may be of more interest or are of higher importance for anomaly identification than other features of SMF records. In such cases, the SMF records analysis engine 412 determines features of interest across each of the SMF records and the features that correlate across SMF record types. For example, jobname and user ID can be considered features of interest for SMF record type 30 records (common address space work record) and SMF record type 92 records (file system activity). However, these features may not be available for other SMF record types, such as SMF record type 42 (DFSMS statistics and configuration). In examples, IBM's Open Data Analytics for zOS (e.g., the Open Data Layer (ODL) component) can be utilized to provide SMF record mapping that enables reading SMF records. After reading the SMF records with the ODL, the present techniques extract the features of interest. Once the features of interest and the features that correlate are determined, the anomaly identification engine 414 can identify a unit of work as causing an anomaly based on a highest occurring number (i.e., a highest count) of the feature of interest, regardless of SMF record type.

The anomalies identified by the anomaly identification 414 can be classified into one or more of at least two classifications. The first classification of anomalies is an existing problem on the system caused by flooding, a spike in CPU usage, or malicious attempts/activities. The second classification of anomalies is day-to-day anomalies that could be detected by comparing detected activities against usual behavior in an environment. For example, over time, as a user generates SMF data, typical behaviors of the user can be learned and compared. Differences in behavior could indicate a potential problem and be reported as an anomaly. For example, variable activity during the end-of-quarter period, from one day to another, at specific times of days, etc. In other words, the present techniques provide for comparing the identified anomaly to historic SMF records to determine whether the anomaly is consistent or inconsistent with historic behavior.

Additional processes also may be included. For example, the method 600 can include implementing, by the anomaly mitigation engine 416, a mitigation action based at least in part on the unit of work identified as flooding the SMF records. The mitigation action can include but is not limited to: suspending a user account, alerting a system administrator of a potential security threat or malicious attack, aborting an operation, etc.

It should be understood that the process depicted in FIG. 5 represents an illustration, and that other processes may be added or existing processes may be removed, modified, or rearranged without departing from the scope of the present disclosure.

Example embodiments of the disclosure include or yield various technical features, technical effects, and/or improvements to technology. Example embodiments of the disclosure provide techniques for identifying an anomaly using SMF records by considering the occurrence of SMF records across multiple SMF record types. These aspects of the disclosure constitute technical features that yield the technical effect of anomaly identification in an efficient and timely way, unable to be performed by a human. As a result of these technical features and technical effects, an anomaly detection system using SMF records across multiple SMF record types in accordance with example embodiments of the disclosure represents an improvement to existing anomaly detection techniques. It should be appreciated that the above examples of technical features, technical effects, and improvements to technology of example embodiments of the disclosure are merely illustrative and not exhaustive.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

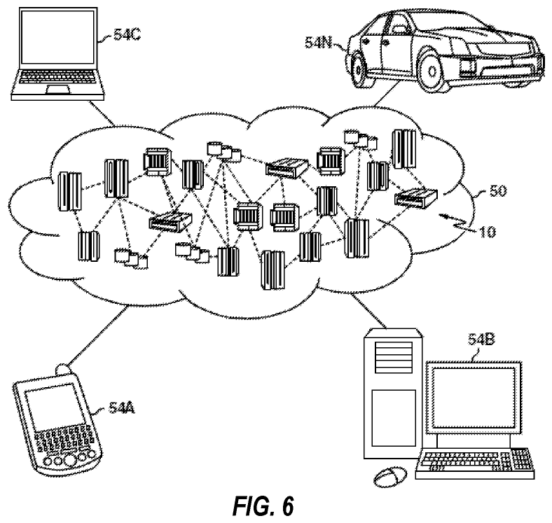

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone MA, desktop computer MB, laptop computer MC, and/or automobile computer system MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

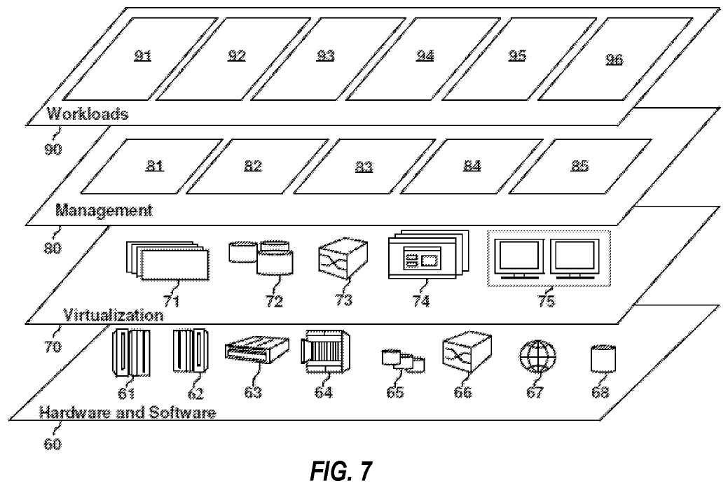

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and detecting anomalies in a processing system using system management facilities records 96.

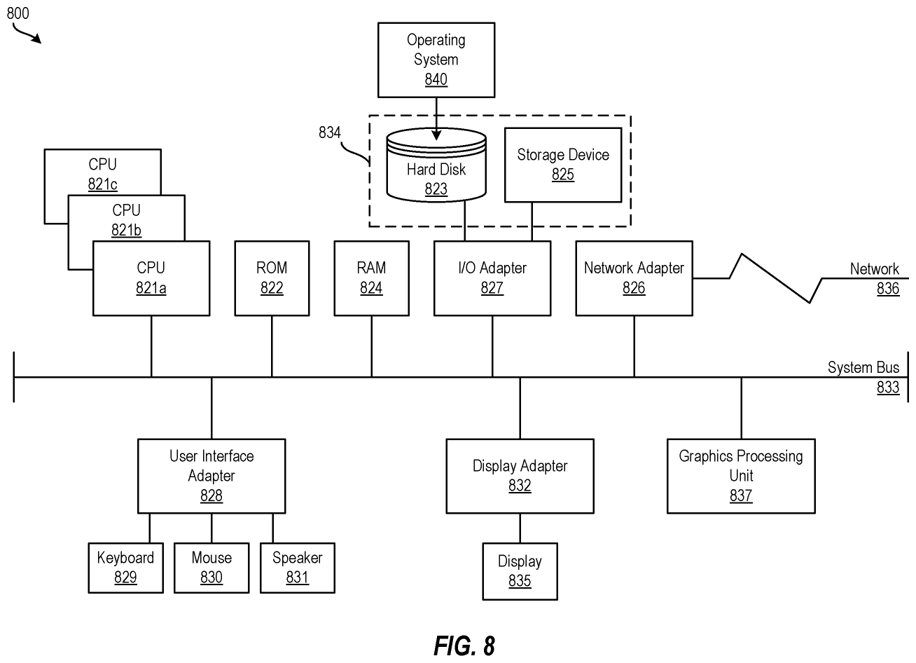

It is understood that the present disclosure is capable of being implemented in conjunction with any other type of computing environment now known or later developed. For example, FIG. 8 depicts a block diagram of a processing system 800 for implementing the techniques described herein. In examples, processing system 800 has one or more central processing units (processors) 821a, 821b, 821c, etc. (collectively or generically referred to as processor(s) 821 and/or as processing device(s)). In aspects of the present disclosure, each processor 821 can include a reduced instruction set computer (RISC) microprocessor. Processors 821 are coupled to system memory (e.g., random access memory (RAM) 824) and various other components via a system bus 833. Read only memory (ROM) 822 is coupled to system bus 833 and may include a basic input/output system (BIOS), which controls certain basic functions of processing system 800.

Further depicted are an input/output (I/O) adapter 827 and a network adapter 826 coupled to system bus 833. I/O adapter 827 may be a small computer system interface (SCSI) adapter that communicates with a hard disk 823 and/or a storage device 825 or any other similar component. I/O adapter 827, hard disk 823, and storage device 825 are collectively referred to herein as mass storage 834. Operating system 840 for execution on processing system 800 may be stored in mass storage 834. The network adapter 826 interconnects system bus 833 with an outside network 836 enabling processing system 800 to communicate with other such systems.

A display (e.g., a display monitor) 835 is connected to system bus 833 by display adapter 832, which may include a graphics adapter to improve the performance of graphics intensive applications and a video controller. In one aspect of the present disclosure, adapters 826, 827, and/or 832 may be connected to one or more I/O busses that are connected to system bus 833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 833 via user interface adapter 828 and display adapter 832. A keyboard 829, mouse 830, and speaker 831 may be interconnected to system bus 833 via user interface adapter 828, which may include, for example, a Super I/O chip integrating multiple device adapters into a single integrated circuit.

In some aspects of the present disclosure, processing system 800 includes a graphics processing unit 837. Graphics processing unit 837 is a specialized electronic circuit designed to manipulate and alter memory to accelerate the creation of images in a frame buffer intended for output to a display. In general, graphics processing unit 837 is very efficient at manipulating computer graphics and image processing, and has a highly parallel structure that makes it more effective than general-purpose CPUs for algorithms where processing of large blocks of data is done in parallel.

Thus, as configured herein, processing system 800 includes processing capability in the form of processors 821, storage capability including system memory (e.g., RAM 824), and mass storage 834, input means such as keyboard 829 and mouse 830, and output capability including speaker 831 and display 835. In some aspects of the present disclosure, a portion of system memory (e.g., RAM 824) and mass storage 834 collectively store the operating system 840 such as the AIX® operating system from IBM Corporation to coordinate the functions of the various components shown in processing system 800.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for anomaly detection based on data records, the method comprising:
receiving, by a processing device, the data records, the data records being of a plurality of data record types;
analyzing, by the processing device, the data records by comparing the data records of different record types; and
identifying, by the processing device and based at least in part on the analyzing, a unit of work that is flooding the data records as the anomaly.

2. The computer-implemented method of claim 1, further comprising:
implementing a mitigation action based at least in part on the unit of work identified as flooding the data records.

3. The computer-implemented method of claim 1, wherein the method is implemented as an application programming interface.

4. The computer-implemented method of claim 1, further comprising identifying a second anomaly by identifying features of interest across multiple data record types and determining a highest occurring feature of interest as being the second anomaly.

5. The computer-implemented method of claim 1, further comprising comparing the identified anomaly to historic data records to determine whether the anomaly is consistent or inconsistent with historic behavior.

6. The computer-implemented method of claim 1, wherein analyzing the data records further comprises sorting occurrences of identification features.

7. The computer-implemented method of claim 6, wherein identifying the unit of work that is flooding the data records as the anomaly further comprises aggregating the data records created by each of a plurality of units of work, across record types, and identifying a highest count unit of work of the plurality of units of work as being the unit of work that is flooding the data records.

8. The computer-implemented method of claim 1, wherein the data records are system management facilities records.

9. A system comprising:
a memory comprising computer readable instructions; and
a processing device for executing the computer readable instructions for performing a method for anomaly detection based on data records, the method comprising:
receiving, by the processing device, the data records, the data records being of a plurality of data record types;
analyzing, by the processing device, the data records by comparing the data records of different record types; and
identifying, by the processing device and based at least in part on the analyzing, a unit of work that is flooding the data records as the anomaly.

10. The system of claim 9, wherein the method further comprises:
implementing a mitigation action based at least in part on the unit of work identified as flooding the data records.

11. The system of claim 9, wherein the method is implemented as an application programming interface.

12. The system of claim 9, wherein the method further comprises identifying a second anomaly by identifying features of interest across multiple data record types and determining a highest occurring feature of interest as being the second anomaly.

13. The system of claim 9, wherein the method further comprises comparing the identified anomaly to historic data records to determine whether the anomaly is consistent or inconsistent with historic behavior.

14. The system of claim 9, wherein analyzing the data records further comprises sorting occurrences of identification features.

15. The system of claim 14, wherein identifying the unit of work that is flooding the data records as the anomaly further comprises aggregating the data records created by each of a plurality of units of work, across record types, and identifying a highest count unit of work of the plurality of units of work as being the unit of work that is flooding the data records.

16. The system of claim 9, wherein the data records are system management facilities records.

17. A computer program product comprising:
a computer readable storage medium having program instructions embodied therewith, the program instructions executable by a processing device to cause the processing device to perform a method for anomaly detection based on data records, the method comprising:
receiving, by the processing device, the data records, the data records being of a plurality of data record types;
analyzing, by the processing device, the data records by comparing the data records of different record types; and
identifying, by the processing device and based at least in part on the analyzing, a unit of work that is flooding the data records as the anomaly.

18. The computer program product of claim 17, wherein the method further comprises:
implementing a mitigation action based at least in part on the unit of work identified as flooding the data records.

19. The computer program product of claim 17, wherein the method is implemented as an application programming interface.

20. The computer program product of claim 17, wherein the method further comprises identifying a second anomaly by identifying features of interest across multiple data record types and determining a highest occurring feature of interest as being the second anomaly.
